(19) United States
(12) Patent Application Publication
(10) Pub. No.: US 2018/0190089 A1
(43) Pub. Date: Jul. 5, 2018

(54) FLASH ALERT APPARATUS, SYSTEM, AND METHOD

(71) Applicants: Wilmar Valverde, Seymour (CT); Paul R. Hebert, Manchester, CT (US); Kevin O'Neill, Branford, CT (US)

(72) Inventors: Wilmar Valverde, Seymour (CT); Paul R. Hebert, Manchester, CT (US); Kevin O'Neill, Branford, CT (US)

(21) Appl. No.: 15/395,699

(22) Filed: Dec. 30, 2016

(51) Int. Cl. G08B 7/06; G08B 17/10; G08B 25/10

(52) U.S. Cl. CPC G08B 7/064; G08B 25/10; G08B 17/10

(57) ABSTRACT

A flash alert apparatus comprising: a first smoke alarm, the first smoke alarm comprising a motion sensor and a wireless transmitter; a first alerting component configurable to be wireless communication and synchronized with the first smoke alarm, the first alerting component comprising: a light configured to flash; and a first wireless receiver configurable to be in wireless communication with the first wireless transmitter. A flash alert system comprising: a first smoke alarm installed on a wall or ceiling, the first smoke alarm comprising a motion sensor and a first wireless transmitter; a first alerting component in wireless communication and synchronized with the first smoke alarm and attached to the inside of an outside window such that the light will be seen outdoors when it flashes, the first alerting component comprising: a first light configured to flash; and a first wireless receiver in signal communication with the first wireless transmitter. A flash alert method, the flash alert method comprising: installing an alerting component in a window to the outside; installing a smoke alarms with a motions sensor in the room with the alerting component or room adjacent to the rooms with the alerting component; synchronizing the smoke alarms to the alerting component; testing the system, and verifying that the alerting components is synched to the smoke alarm, and that the alerting components will flash when a signal is sent to it from the smoke alarm. A flash alert method, the flash alert method comprising: detecting smoke; activating audible alarm; determining whether a motion sensor detected any motion at a time period after the alarm is activated; sending a signal from a smoke alarm to a synched alerting component instructing alerting component to flash its light.

### TECHNICAL FIELD

The present invention relates to a room occupant alert and more specifically to a fire alarm and motion detector system in communication with a room occupant alert which notifies whether a room may be occupied.

### BACKGROUND

Fires in homes and businesses cause the death of many people every year. Often, after a fire, one or more bodies may be found in rooms. Currently there is no known way to determine quickly where people and pets may be located in a building during a fire. Often, firefighters must search room to room to find occupants, which takes up precious time, and the delay in going room to room can lead to the loss of life.

Thus there is a need for a flash alert apparatus, system, and method that overcomes the above listed and other disadvantages.

### SUMMARY OF THE INVENTION

The invention relates to a flash alert apparatus comprising: a first smoke alarm, the first smoke alarm comprising a motion sensor and a wireless transmitter; a first alerting component configurable to be wireless communication and synchronized with the first smoke alarm, the first alerting component comprising: a light configured to flash; and a first wireless receiver configurable to be in wireless communication with the first wireless transmitter.

The invention also relates to a flash alert system comprising: a first smoke alarm installed on a wall or ceiling, the first smoke alarm comprising a motion sensor and a first wireless transmitter; a first alerting component in wireless communication and synchronized with the first smoke alarm and attached to the inside of an outside window such that the light will be seen outdoors when it flashes, the first alerting component comprising: a first light configured to flash; and a first wireless receiver in signal communication with the first wireless transmitter.

In addition, the invention relates to a flash alert method, the flash alert method comprising: installing an alerting component in a window to the outside; installing a smoke alarms with a motions sensor in the room with the alerting component or room adjacent to the rooms with the alerting component; synchronizing the smoke alarms to the alerting component; testing the system, and verifying that the alerting components is synched to the smoke alarm, and that the alerting components will flash when a signal is sent to it from the smoke alarm.

Also, the invention relates to a flash alert method, the flash alert method comprising: detecting smoke; activating audible alarm; determining whether a motion sensor detected any motion at a time period after the alarm is activated; sending a signal from a smoke alarm to a synched alerting component instructing alerting component to flash its light.

### BRIEF DESCRIPTION OF THE DRAWINGS

The present disclosure will be better understood by those skilled in the pertinent art by referencing the accompanying drawings, where like elements are numbered alike in the several figures, in which:

FIG. 1 is a perspective view of the flash alert apparatus;

FIG. 2 is a front view of the smoke alarm;

FIG. 3 is a front view of the alerting component;

FIG. 4 is a perspective view of the smoke alarm;

FIG. 5 is a side view of the smoke alarm;

FIG. 6 is a front view of a window with the alerting component install on it;

FIG. 7 is a perspective view of the alerting component;

FIG. 8 is a rear view of the alerting component;

FIG. 9 is a plan view of a home with the flash alert system installed;

FIG. 10 is a plan view of a home with another embodiment of the flash alert system installed;

FIG. 11 is a flowchart showing one embodiment of a method of the invention; and

FIG. 12 is a flowchart showing another embodiment of a method of the invention.

### DETAILED DESCRIPTION OF THE INVENTION

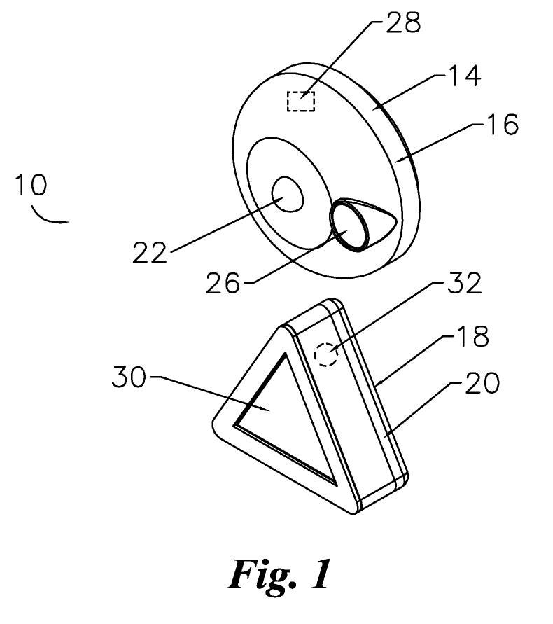

FIG. 1 shows one embodiment of the flash alert system 10. The system 10 may comprise a smoke alarm 14 paired with an alerting component 18. The smoke alarm 14 comprises a motion sensor 22. In other embodiments, the smoke alarm 14 may also comprise a warning light 26. The warning light 26 may be a flashing LED light. The smoke alarm 14 also comprises a transmitter 28, shown in dashed lines because in one embodiment it will be located within the smoke alarm 14 housing 16. The alerting component 18 comprises a light 30 that is configured to flash upon receiving a signal from the smoke alarm 14. The alerting component 18 comprises a receiver 32 configured to receive signals from the smoke alarm 14 transmitter 28. The receiver 32 is shown in dashed lines because in one embodiment it will be located within the alerting component 18 housing 20. The smoke alarm 14 and alerting component 18 may each comprise an audible alarm.

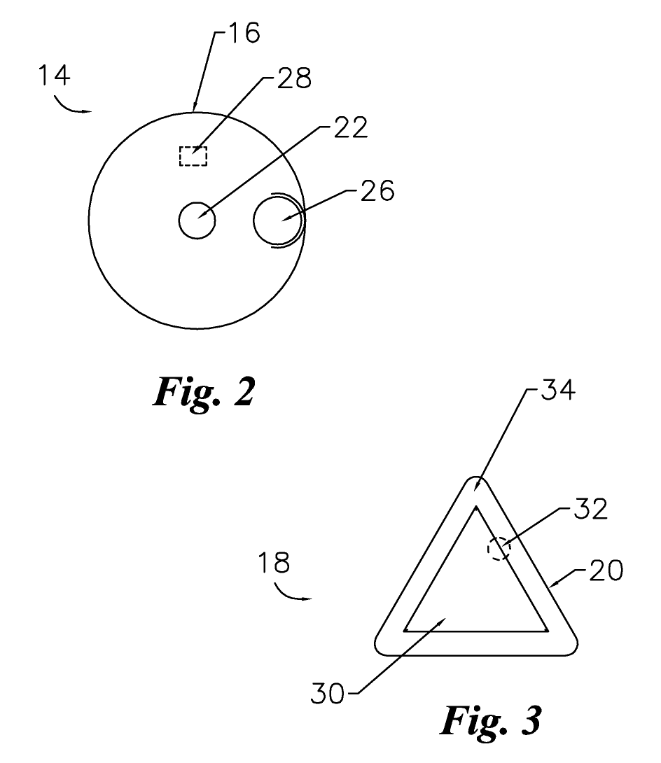

FIG. 2 is a front view of the smoke alarm 14. The motion sensor 22 may be a 360° motion sensor, configured to detect motion 360° around the smoke alarm 14.

FIG. 3 is a front view of the alerting component 18. The light 30 may be a flashing LED light, with a red lense. The front of the housing 20 may have double sided tape 34 with a removable non-stick layer, configured such that when a user installs the alerting component, she simply removes the non-stick layer, and sticks the alerting component 18 onto the inside surface of a window that faces outside. In this way, when the alerting component 18 activates, the light 30 flashes, and people outside the house will see the flashing light, and know there is a person inside the room where the flashing alerting component 18 is located.

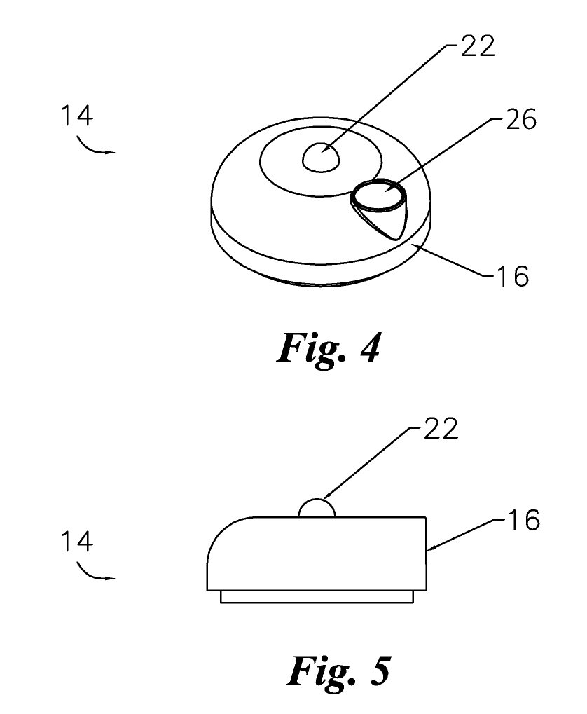

FIG. 4 is a perspective view of the smoke alarm 14.

FIG. 5 is a side view of the smoke alarm 14. In this view, the motion sensor 22 is shown extending out from the smoke alarm housing 16. This helps the motion sensor 22 to better detect motion in a 360° range around the smoke alarm 14.

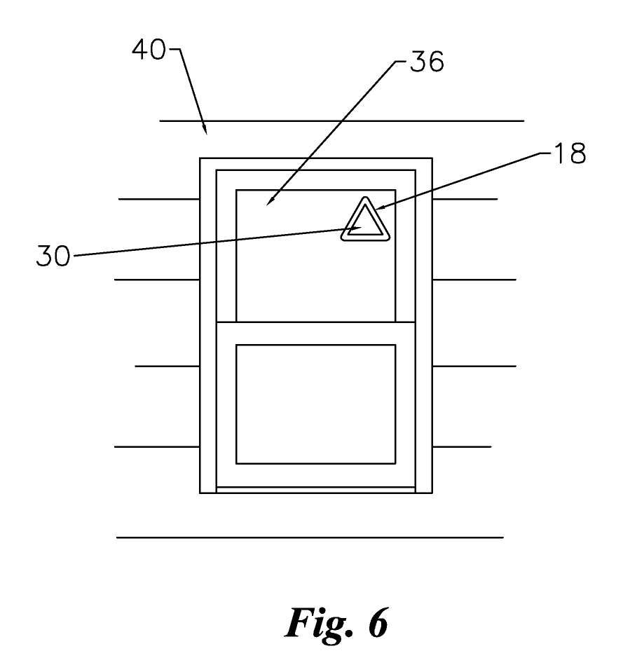

FIG. 6 is one embodiment of how the alerting component 18 may be attached to a window 36. Generally the user will choose a window 36 of her home, office, or other building 40 that faces outside. The user can install the alerting component 18 on the interior glass pane of the window 36 so that the light 30 faces outside.

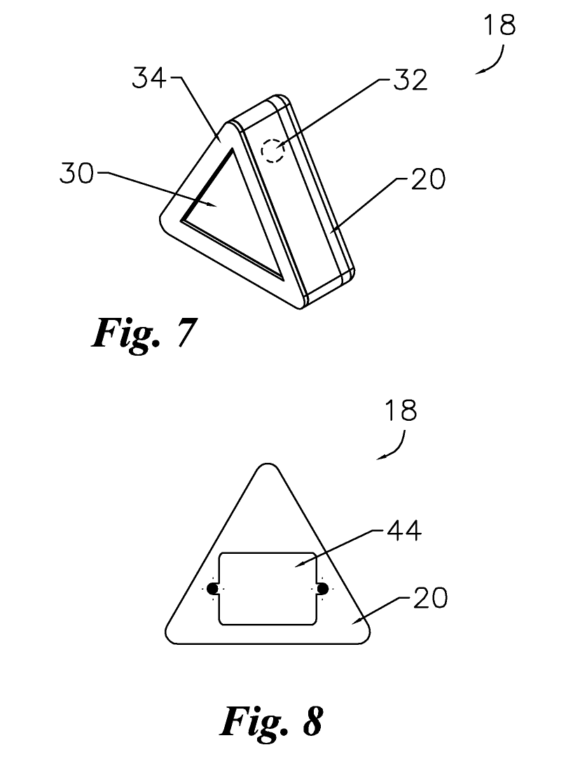

FIG. 7 is a perspective view of the alerting component 18.

FIG. 8 is a rear view of the alerting component 18. In this view, an access panel 44 is shown that allows one to install and replace batteries in the component 18.

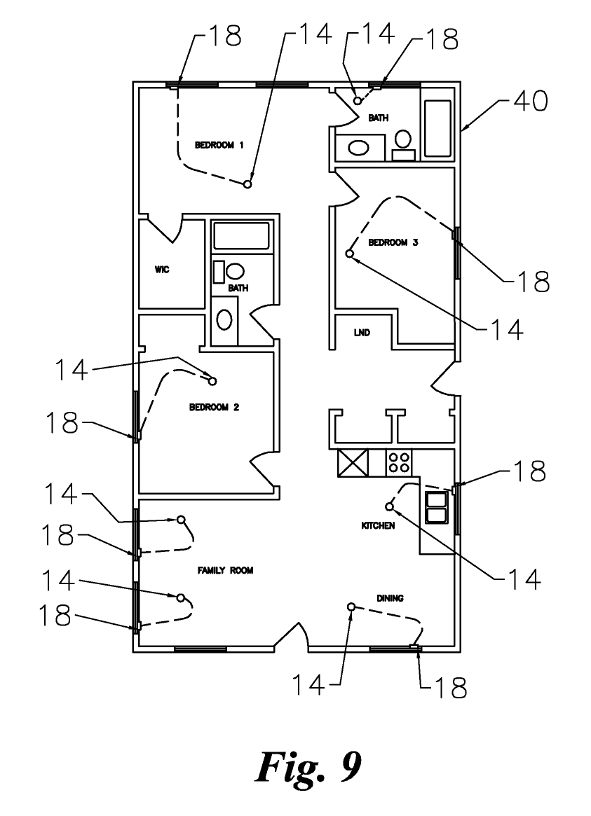

FIG. 9 shows one embodiment of the flash alert system installed in a building 40, in this case a home. In this figure, the circles represent the smoke alarms 14, and the squares on the windows represent the alerting component 18. In this embodiment, each smoke alarm 14 is paired or in wireless communication with one alerting component 18. There is a dashed line between each smoke detector 14 and each alerting component 18, representing the wireless communication. For instance, in bedroom 1, the smoke alarm 14 is pair with the alerting component 18 in the window of bedroom 1. Similarly, in the bathroom adjacent to bedroom 1 and bedroom 3, there is a smoke alarm 14 paired with the alerting component 18 in the bathroom window. There is one smoke alarm 14 in the dining room that is paired with the alerting component 18 in the kitchen window.

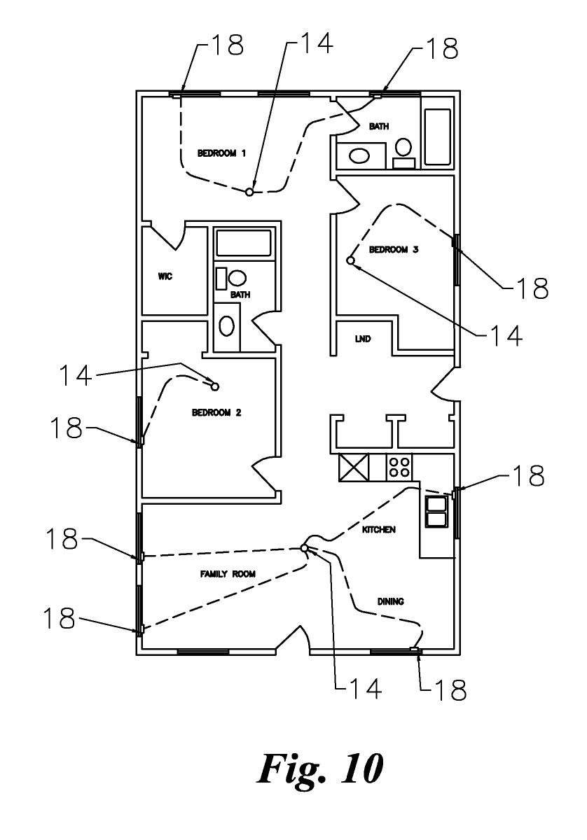

FIG. 10 shows another embodiment of the flash alert system installed in a home 40. In this embodiment, the smoke alarms may be paired or in wireless communication with more than one alerting component 18. There is a dashed line between each smoke detector 14 and the one or more alerting components 18 the smoke detector 14 is in wireless communication with. Thus in bedroom 1, the smoke detector 14 is in wireless communication with the alerting components 18 in the window of bedroom 1, and the window of the bathroom. In the family room/dining room; the smoke detector 14 is in wireless communication with the four alerting components 18 as shown.

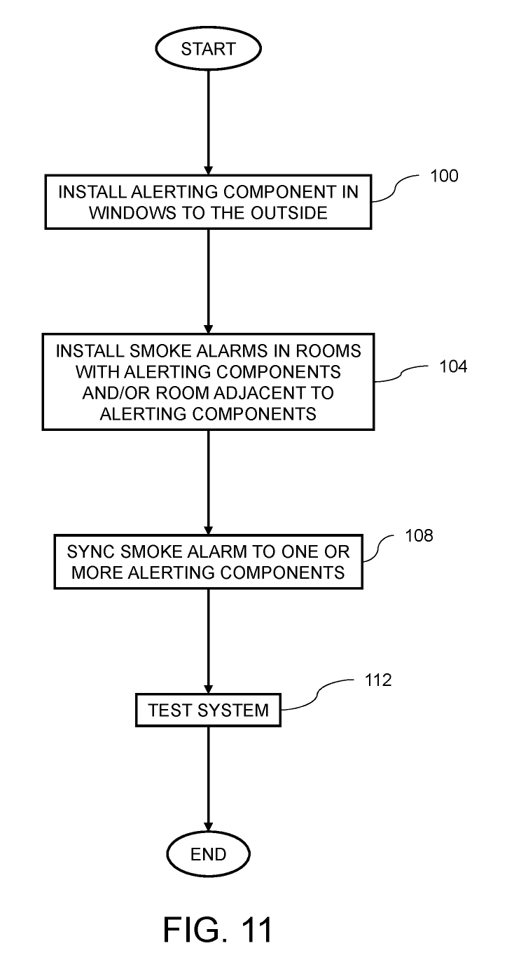

FIG. 11 is a flowchart showing one embodiment of installing the flash alert system. At act 100, the user installs the alerting component in windows to the outside. At act 104, the user installs the smoke alarms with motions sensors in room with the alerting components or room adjacent to rooms with the alerting components. At act 108, the user synchronizes the smoke alarms to one or more of the alerting components. At act 112, the user may test the system, verifying that each of the alerting components is synched to a smoke alarm, and that each of the alerting components will flash when a signal is sent to them from the smoke alarm.

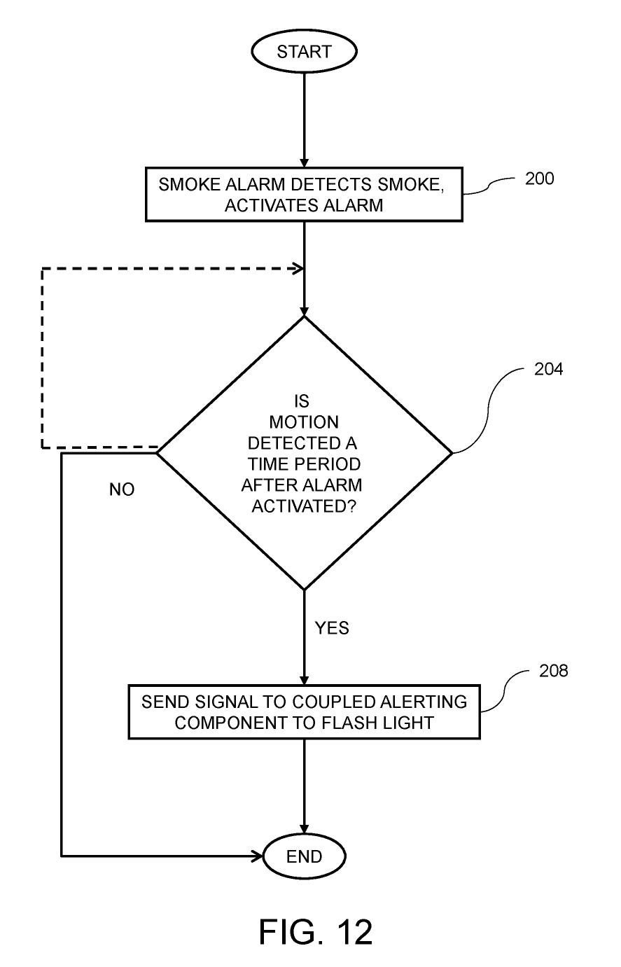

FIG. 12 is a flowchart of one embodiment of how the flash alert system may operate. At act 200, the smoke alarm detects smoke, and activates an audible alarm. At query 204, it is determined whether the motion sensor detected any motion at a time period after the alarm is activated. In one embodiment, the time period may be 1 minute, but other time periods may be used, such as but not limited to 30 seconds, 2 minutes, etc. If motion is detected after the time period, then a signal is sent from the smoke alarm to a synched alerting component instructing the alerting component to flash its light. If motion is not detected, after the time period, then the process may end. In another embodiment, if motion is not detected, then the process may go back to query 204, in order to detect motion at any time after the time period.

This invention has many advantages. It is easy to set up, install, synchronize and test. The system allows firefighters and others to quickly determine in what rooms survivors may be located during a fire or smoke emergency situation.

It should be noted that the terms “first”, “second”, and “third”, and the like may be used herein to modify elements performing similar and/or analogous functions. These modifiers do not imply a spatial, sequential, or hierarchical order to the modified elements unless specifically stated.

While the disclosure has been described with reference to several embodiments, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiments disclosed as the best mode contemplated for carrying out this disclosure, but that the disclosure will include all embodiments falling within the scope of the appended claims.

What is claimed is:

1. A flash alert apparatus comprising:
a first smoke alarm, the first smoke alarm comprising a motion sensor and a wireless transmitter;
a first alerting component configurable to be wireless communication and synchronized with the first smoke alarm, the first alerting component comprising:
a light configured to flash if the motion sensor detected any motion at a time period after the smoke alarm is activated; and
a first wireless receiver configurable to be in wireless communication with the first wireless transmitter.

2. The flash alert apparatus of claim 1, wherein the first alerting component is configurable to attach to the inside of an outdoor window, such that the light will be seen outdoors when it flashes.

3. The flash alert apparatus of claim 1, wherein the first alerting component comprises:
a housing;
an attachment means located on the front of the housing.

4. The flash alert apparatus of claim 3, wherein the attachment means is double sided tape.

5. The flash alert apparatus of claim 1, further comprising a second alerting component configurable to be wireless communication and synchronized with the first smoke alarm, the second alerting component comprising:
a light configured to flash if the motion sensor detected any motion at a time period after the smoke alarm is activated; and
a second wireless receiver configurable to be in wireless communication with the first wireless transmitter.

6. A flash alert system comprising:
a first smoke alarm installed on a wall or ceiling, the first smoke alarm comprising a motion sensor and a first wireless transmitter;
a first alerting component in wireless communication and synchronized with the first smoke alarm and attached to the inside of an outside window, the first alerting component comprising:
a first light configured to flash if the motion sensor detected any motion at a time period after the smoke alarm is activated, the first light further configured such that the light will be seen outdoors when it flashes; and
a first wireless receiver in signal communication with the first wireless transmitter.

7. The flash alert system of claim 6, further comprising a second alerting component in wireless communication and synchronized with the first smoke alarm and attached to the inside of an outside window such that the light will be seen outdoors when it flashes, the second alerting component comprising:
a light configured to flash; and
a second wireless receiver configurable to be in wireless communication with the first wireless transmitter.

8. The flash alert system of claim 6, wherein the smoke alarm further comprises:
a warning light configured to activate when smoke is detected.

9. A flash alert method, the flash alert method comprising:
installing an alerting component in a window to the outside;
installing a smoke alarms with a motions sensor in the room with the alerting component or room adjacent to the rooms with the alerting component;
synchronizing the smoke alarms to the alerting component;
testing the system, and verifying that the alerting components is synched to the smoke alarm, and that the alerting components will flash when a signal is sent to it from the smoke alarm.

10. A flash alert method, the flash alert method comprising:
detecting smoke;
activating audible alarm;
determining whether a motion sensor detected any motion at a time period after the alarm is activated;
sending a signal from a smoke alarm to a synched alerting component instructing alerting component to flash its light.

11. The flash alert method of claim 10, wherein the time period is 1 minute.
